(19) United States
(12) Patent Application Publication
(10) Pub. No.: US 2023/0090074 A1
(43) Pub. Date: Mar. 23, 2023

(54) ARM, TOOL MAGAZINE, AND MACHINE TOOL

(71) Applicant: BROTHER KOGYO KABUSHIKI KAISHA, Nagoya-shi (JP)

(72) Inventors: Shunsuke TSUJI, Nagoya-shi (JP); Kunihiko UNO, Nagoya-shi (JP)

(73) Assignee: BROTHER KOGYO KABUSHIKI KAISHA, Nagoya-shi (JP)

(21) Appl. No.: 18/072,861

(22) Filed: Dec. 1, 2022

Related U.S. Application Data
(63) Continuation of application No. PCT/JP2021/023564, filed on Jun. 22, 2021.

(30) Foreign Application Priority Data
Jun. 30, 2020 (JP) 2020-113512

(51) Int. Cl. B23Q 3/157

(52) U.S. Cl. CPC B23Q 3/15722

(57) ABSTRACT

Provided are an arm, a tool magazine, and a machine tool capable of suppressing interference between tool storage arms and suppressing an increase in size in the direction parallel to an axis of rotation. The arm is provided in the tool magazine of the machine tool and configured to grip a tool. The arm includes a support plate configured to be fixed to the tool magazine and two support rods configured to rotate on both sides of the support plate. The positions of the tool grip side end portions of the two support rods are different in the rotation center axis direction of the tool magazine.

### REFERENCE TO RELATED APPLICATIONS

This application is a continuation application of PCT International Application No. PCT/JP2021/023564 which has an international filing date of Jun. 22, 2021 and designated the United States of America, and claiming priority from Japanese Patent Application No. 2020-113512 filed on Jun. 30, 2020. The entire content of the priority application is incorporated herein by reference.

### BACKGROUND ART

This technique relates to an arm gripping a tool, a tool magazine including the arm, and a machine tool including the tool magazine.

In the related art, a machine tool is provided with a tool magazine, and the tool magazine has an arm for a large-diameter tool and an arm for a small-diameter tool. The arm for a large-diameter tool and the arm for a small-diameter tool are adjacent to each other. The position of the arm for a large-diameter tool and the position of the arm for a small-diameter tool are different in the direction parallel to the axis of rotation of the tool magazine. Accordingly, interference can be prevented between the arm for a large-diameter tool and the arm for a small-diameter tool.

### DESCRIPTION

The arm for a large-diameter tool or the arm for a small-diameter tool protrudes in the direction parallel to the axis of rotation and is stepped. Accordingly, the tool magazine increases in size in the direction parallel to the axis of rotation.

An object of the present disclosure is to provide an arm and a tool magazine and a machine tool including the arm capable of suppressing inter-arm interference and suppressing an increase in size in the direction parallel to an axis of rotation.

An arm of the present disclosure is provided in a tool magazine of a machine tool and configured to grip a tool. The arm includes: a support plate configured to be fixed to the tool magazine; and two support rods configured to rotate on both sides of the support plate, in which positions of tool grip side end portions of the two support rods are different in a rotation axis direction of the tool magazine.

Accordingly, two adjacent arms can be overlapped in the direction parallel to an axis of rotation. A worker does not have to misalign the position of the other arm as a whole with respect to one arm in the direction parallel to the axis of rotation.

In the arm of the present disclosure, the tool grip side end portion of one of the support rods and the tool grip side end portion of the other support rod are separated from each other in the rotation center axis direction.

In the two adjacent arms, the tool grip side end portion of one support rod in one arm and the tool grip side end portion of the other support rod in the other arm do not overlap in the rotation axis direction.

In the arm of the present disclosure, one of the support rods has: a first part extending in a direction orthogonal to the rotation axis of the tool magazine; a first inclined portion extending toward one direction parallel to the rotation axis from one end portion of the first part; and a first grip portion provided on the same side as the one direction in the other end portion of the first part and configured to grip a tool, the other support rod has: a second part extending in a direction orthogonal to the rotation axis; a second inclined portion extending toward the other direction parallel to the rotation axis from one end portion of the second part; and a second grip portion fixed to the same side as the other direction in the other end portion of the second part and configured to grip a tool, and the first grip portion and the second grip portion are at the same position in the rotation axis direction.

In the arm of the present disclosure, in the rotation axis direction, the directions in which the first inclined portion and the second inclined portion extend are opposite, the positions of fixing of the first grip portion and the second grip portion are opposite, and thus the positions of fixing of the first grip portion and the second grip portion are the same. The arm has a configuration in which the same support rods are disposed in opposite directions, and thus there is no need to create support rods separately and component management is facilitated.

In the arm of the present disclosure, one of the support rods includes a first pivot extending in the direction parallel to the rotation axis, the first inclined portion is connected to the first pivot, the other support rod includes a second pivot extending in the direction parallel to the rotation axis, the second inclined portion is connected to the second pivot, positions of the first pivot and the second pivot in the direction parallel to the rotation axis are the same, inclination angle magnitudes of the first inclined portion and the second inclined portion are the same, and lengths of the first inclined portion and the second inclined portion are the same.

In the arm of the present disclosure, in the rotation axis direction, the directions in which the first inclined portion and the second inclined portion extend are opposite, the positions of fixing of the first grip portion and the second grip portion are opposite, and thus the positions of fixing of the first grip portion and the second grip portion are the same. The arm has a configuration in which the same support rods are disposed in opposite directions, and thus there is no need to create support rods separately and component management is facilitated.

In the arm of the present disclosure, an urging member urging the first grip portion and the second grip portion in a closing direction is provided between the two support rods.

The arm of the present disclosure grips a tool by the urging force of the urging member.

A tool magazine of the present disclosure includes the arm described above. One end portion of the arm protrudes outward from a peripheral edge portion of a turntable in a direction intersecting a rotation axis of the turntable, and the other end portion of the arm is disposed at a position not facing the rotation axis of the turntable in a longitudinal direction of the arm.

The arm of the present disclosure is disposed so as to intersect a line passing through the center of the turntable and extending in the radial direction of the rotation axis. Accordingly, the two adjacent arms easily overlap at least in part.

A machine tool of the present disclosure includes the tool magazine described above.

The machine tool of the present disclosure is similar in action and effect to the arm and the tool magazine described above.

In the arm, the tool magazine, and the machine tool of the present disclosure, the positions of the tool grip side end portions of the two support rods in the rotation axis direction of the tool magazine are different. Accordingly, the two adjacent arms overlap in the direction parallel to the rotation axis simply by arranging the arms in the circumferential direction of the tool magazine. There is no need to misalign the position of the other arm as a whole with respect to one arm in the direction parallel to the rotation axis. Accordingly, it is possible to suppress the tool magazine increasing in size in the direction parallel to the rotation axis.

The above and further objects and features will more fully be apparent from the following detailed description with accompanying drawings.

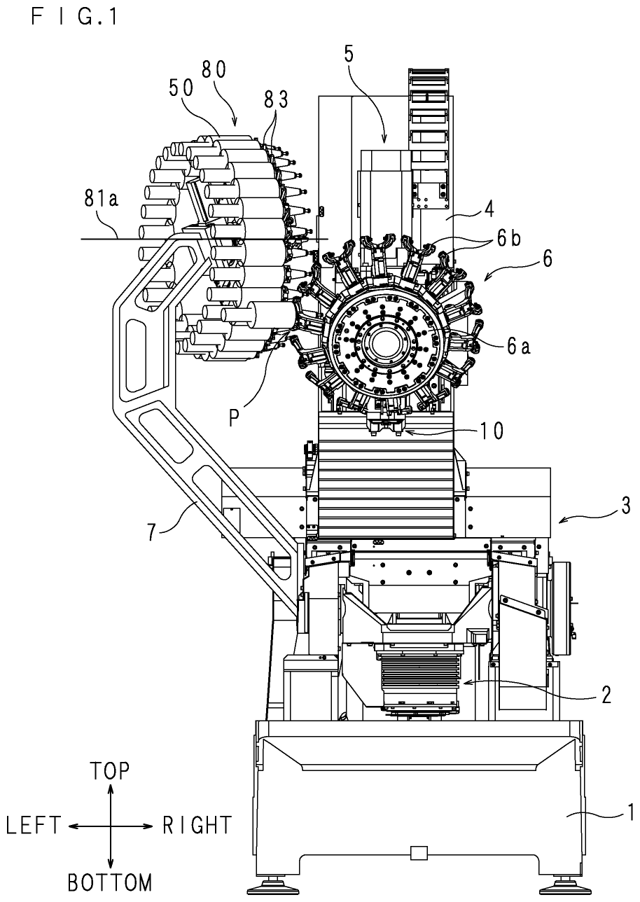

FIG. 1 is a schematic front view of a machine tool.

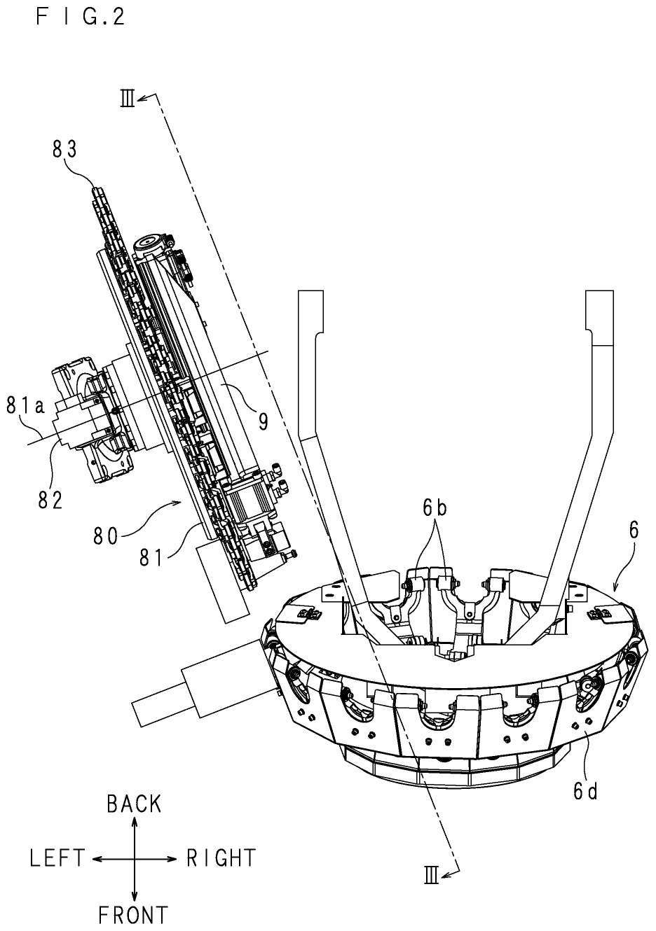

FIG. 2 is a schematic plan view of a first magazine, a second magazine, and a tool transfer device.

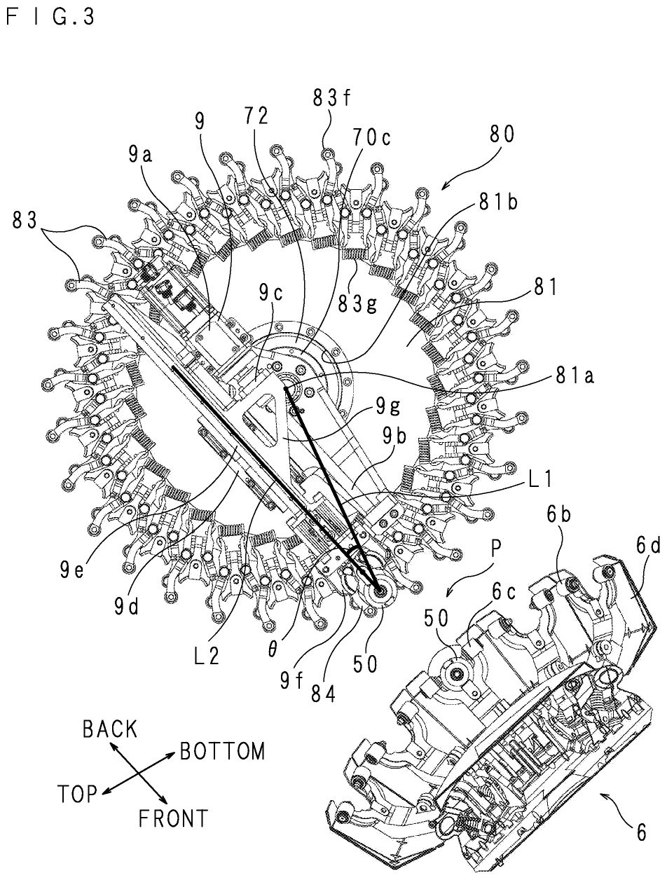

FIG. 3 is a schematic cross-sectional view taken along line III-IH in FIG. 2 as a cutting line.

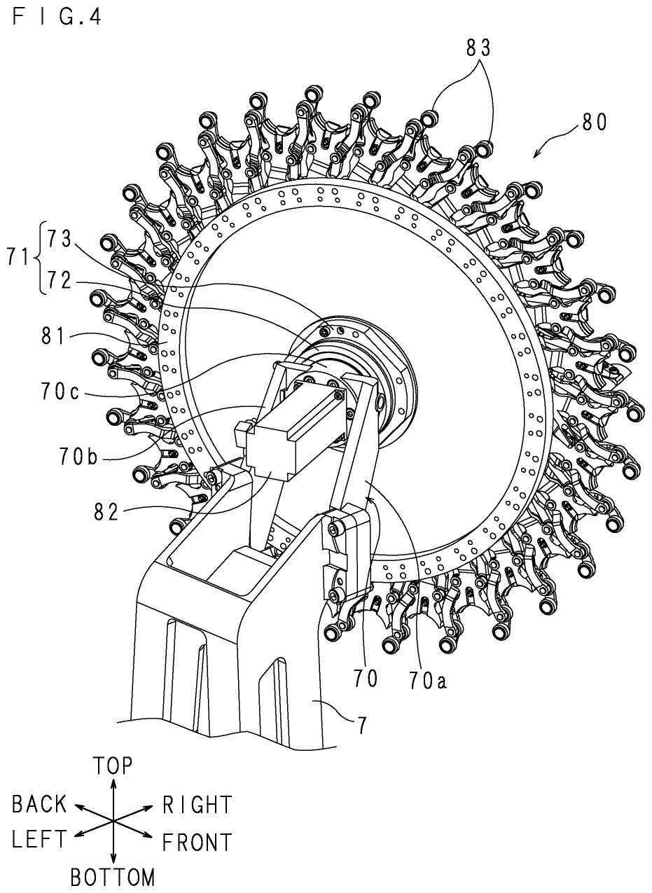

FIG. 4 is a rear perspective view of the vicinity of the second magazine.

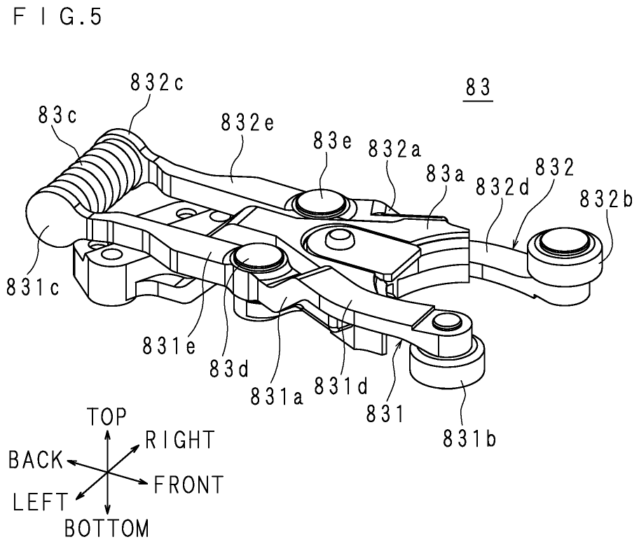

FIG. 5 is a schematic perspective view of an arm viewed from the upper left.

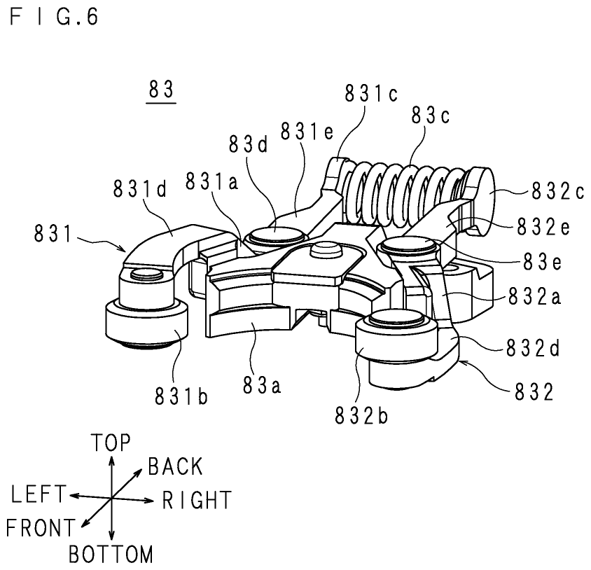

FIG. 6 is a schematic perspective view of the arm viewed from the upper right.

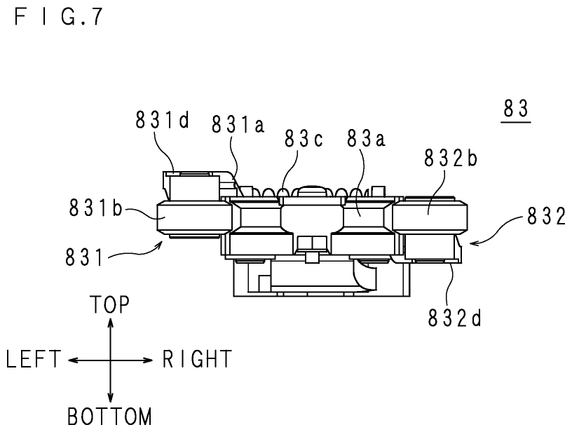

FIG. 7 is a schematic front view of the arm.

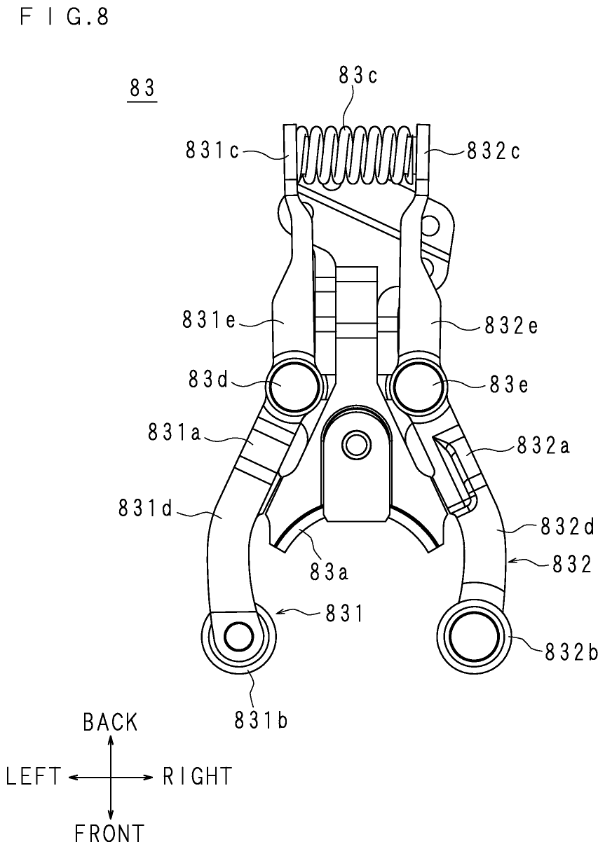

FIG. 8 is a plan view of the arm.

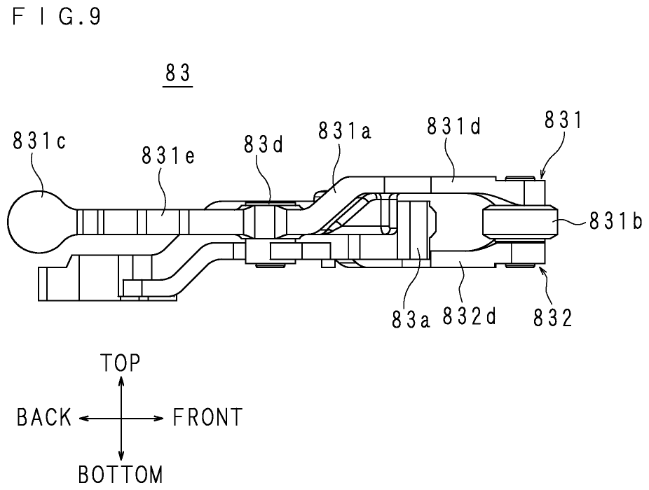

FIG. 9 is a schematic left side view of the arm.

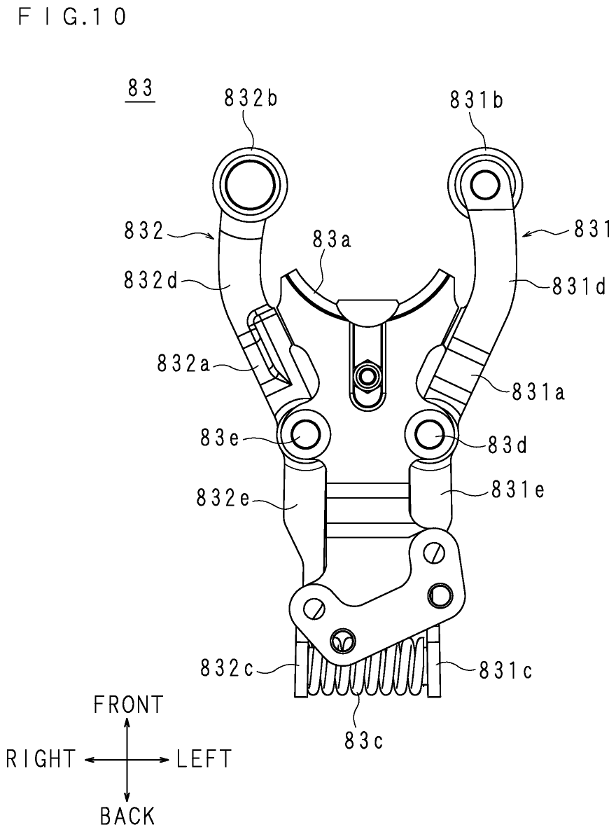

FIG. 10 is a schematic bottom view of the arm.

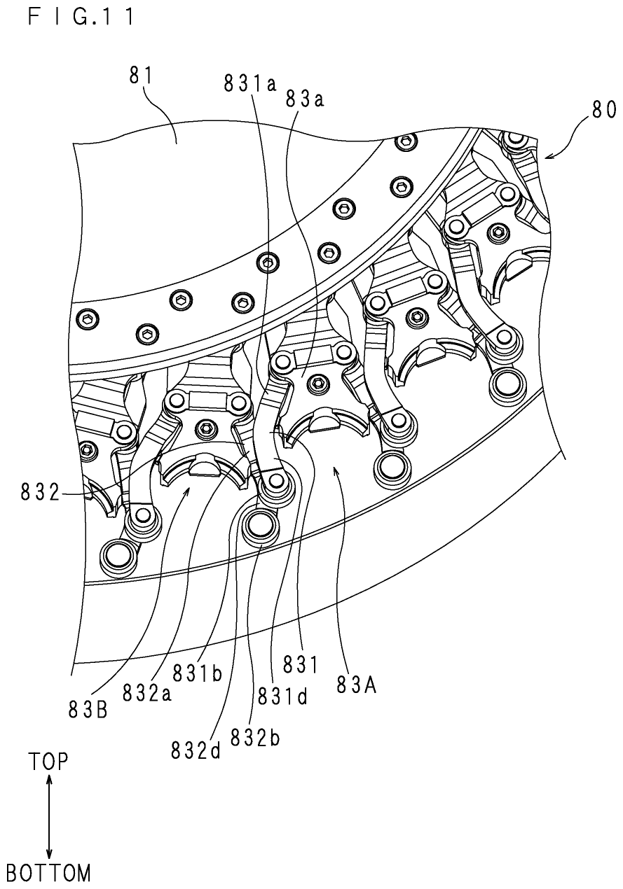

FIG. 11 is a schematic partially enlarged perspective view of the configuration of the vicinity of the arm.

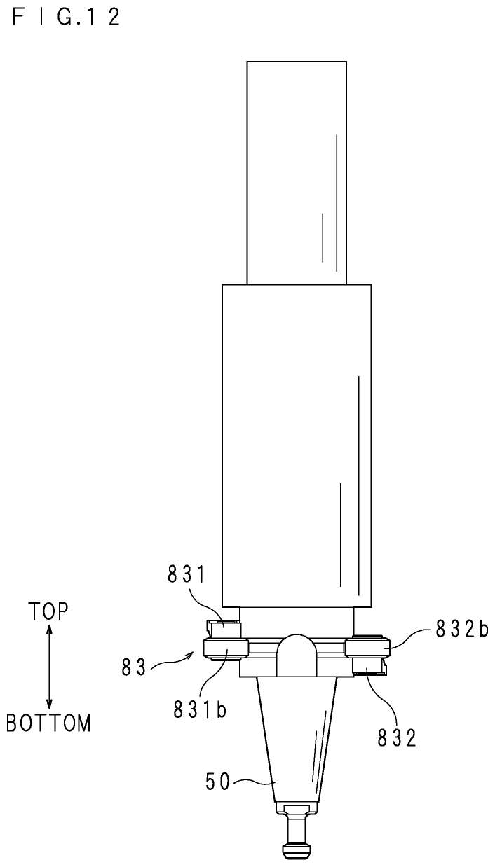

FIG. 12 is a schematic front view of a tool-gripping arm.

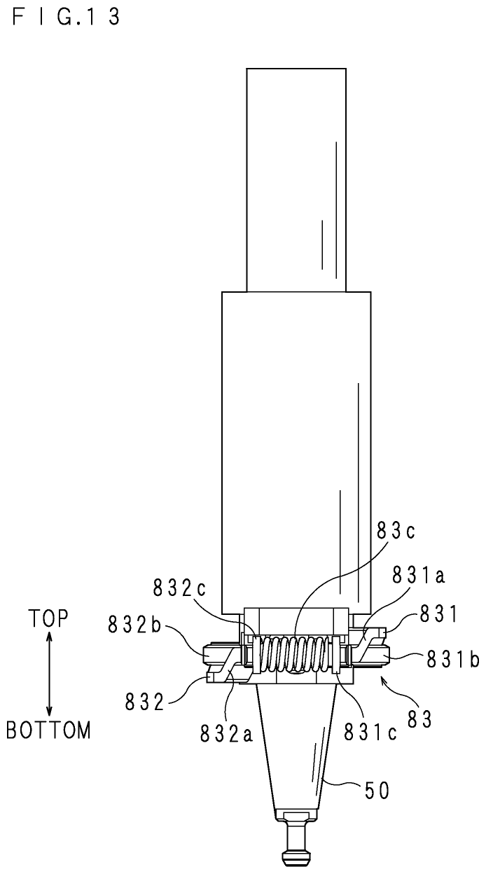

FIG. 13 is a schematic rear view of the tool-gripping arm.

Hereinafter, the machine tool of the present invention will be described with reference to the drawings. In the following description, the top, bottom, front, back, left, and right illustrated in the drawings are used.

The machine tool includes, for example, a base 1, a workpiece holding portion 2, an XY moving mechanism 3, a vertical column 4, a Z moving mechanism 5, a first magazine 6, a support portion 7, a second magazine 80, a tool transfer device 9 (see FIGS. 2 and 3), and a spindle head 10.

The base 1 has a rectangular shape in a plan view and extends in the front-rear direction. The workpiece holding portion 2 is provided on the upper front side of the base 1. On the base 1, the XY moving mechanism 3 capable of moving in the left-right direction (X direction) and the front-rear direction (Y direction) is provided on the rear side of the workpiece holding portion 2.

The vertical column 4 is provided on the upper side of the XY moving mechanism 3. The Z moving mechanism 5 capable of moving in the up-down direction (Z direction) is provided on the front surface of the vertical column 4. The Z moving mechanism 5 is provided with the spindle head 10. The spindle head 10 includes a spindle extending up and down. A tool is mounted in the lower end portion of the spindle.

The first magazine 6 is provided on the front side of the spindle head 10. The first magazine 6 is connected to the vertical column 4 via a connecting member. The first magazine 6 includes a disk 6a and arms 6b. A motor (not illustrated) is connected to the disk 6a, and the disk 6a rotates around the central axis thereof by the drive of the motor. The plurality of arms 6b are radially provided in the peripheral edge portion of the disk 6a. The arm 6b holds the tool.

The first magazine 6 is disposed such that the central axis of the disk 6a extends in the front-rear direction and the disk 6a is in a forward leaning posture. The lower end position of the first magazine 6 is a tool change position. In a case where the tool is mounted on the spindle, the arm 6b gripping the tool is disposed at the tool change position, and the Z moving mechanism 5 is moved downward. Based on the downward movement of the Z moving mechanism 5, the tool gripped by the arm 6b is mounted on the spindle. In a case where the tool is removed from the spindle, the arm 6b that is empty is disposed at the tool change position, and the Z moving mechanism 5 is moved upward. Based on the upward movement of the Z moving mechanism 5, the arm 6b grips the tool of the spindle, and the tool is released from the spindle.

The tool mounted on the spindle processes the workpiece held in the workpiece holding portion 2. The XY moving mechanism 3 adjusts the front-rear and left-right positions of the tool (spindle) with respect to the workpiece, and the Z moving mechanism 5 adjusts the up-down position of the tool.

The support portion 7 is provided on the rear side of the left portion of the base 1. The support portion 7 extends upward, and the second magazine 80 is provided in the tip portion thereof. The second magazine 80 is disposed on the left side and the rear side of the first magazine 6. The second magazine 80 includes the tool transfer device 9. The tool transfer device 9 performs tool delivery between the arm 6b of the first magazine 6 and an arm 83 of the second magazine 80.

The cutting line of FIG. 3 is orthogonal to the central axis of a support disk 81. The first magazine 6 includes a cover 6d. The cover 6d covers the outside of each arm 6b. The cover 6d is rotatable, rotates together with the arm 6b during tool change with the spindle, and does not hinder the tool change.

As illustrated in FIG. 4, an attachment member 70 is fixed to the upper end portion of the support portion 7. The attachment member 70 includes a front plate portion 70a, a rear plate portion 70b, and a support cylinder 70c. The front plate portion 70a and the rear plate portion 70b extend in the upper right direction from the upper end portion of the support portion 7 and are arranged in the front-rear direction. The axial direction of the support cylinder 70c is the left-right direction, and the support cylinder 70c is connected to the upper end portions of the front plate portion 70a and the rear plate portion 70b.

A reduction gear device 71 is connected to the right portion of the support cylinder 70c. The reduction gear device 71 has an annular inner peripheral portion 72 and an outer peripheral portion 73. The inner peripheral portion 72 is fixed to the peripheral edge portion of the support cylinder 70c. The outer peripheral portion 73 is attached around the inner peripheral portion 72 so as to be rotatable around the axis. In other words, the inner peripheral portion 72 rotatably supports the outer peripheral portion 73.

The second magazine 80 includes the support disk 81, a motor 82, and the arms 83. The support disk 81 configures a turntable. The motor 82 is connected to the left portion of the support cylinder 70c. The support disk 81 is disposed on the right side of the reduction gear device 71 with both surfaces facing left and right. The right surface of the support disk 81 faces slightly rearward, and the left surface faces slightly forward. A through hole 81b (see FIG. 3) penetrating the support disk 81 in the left-right direction is provided in the middle portion of the support disk 81. The support cylinder 70c and the inner peripheral portion 72 extend in the axial direction and are inserted into the through hole 81b. The outer peripheral portion 73 is connected to the left side edge portion of the through hole 81b. The outer peripheral portion 73 is rotated by the drive of the motor 82, and the support disk 81 rotates around a central axis 81a thereof. The central axis 81a configures an axis of rotation and extends in the horizontal direction.

As illustrated in FIG. 1, the arm 6b of the first magazine 6 and the arm 83 of the second magazine 80 are closest to each other at a position below the central axis 81a. The position where the arm 6b of the first magazine 6 and the arm 83 of the second magazine 80 are closest to each other is a magazine tool change position P where the tool of the first magazine 6 and the tool of the second magazine 80 are changed. Hereinafter, the arm 6b of the first magazine 6 arranged at the magazine tool change position P will be referred to as a change position arm 6c, and the arm 83 of the second magazine 80 arranged at the magazine tool change position P will be referred to as a change position arm 84. Tool change is performed between the change position arm 6c and the change position arm 84.

One end portion 83f of the grip arm 83 protrudes radially outward from the peripheral edge portion of the support disk 81. In FIG. 3, L1 indicates a line passing through the central axis 81a of the support disk 81 and the center of a tool 50 gripped by the change position arm 84, and L2 indicates a line along the longitudinal direction of the change position arm 84. The line L2 passes through the middle of the change position arm 84. The line L1 and the line L2 intersect to form a predetermined angle θ (>0). Since each arm 83 positioned at the magazine tool change position P is disposed so as to form the predetermined angle θ, the other end portion 83g of the arm 83 does not face the central axis 81a of the support disk 81.

The tool transfer device 9 is provided on the right side of the support disk 81. The tool transfer device 9 includes a motor 9a, a ball screw 9b, a nut 9c, a track 9d, a slider 9e, a pot 9f, and a connecting portion 9g. The support cylinder 70c and the inner peripheral portion 72 inserted in the through hole 81b support the ball screw 9b and the track 9d. The ball screw 9b is connected to the rotating shaft of the motor 9a. The nut 9c is connected to the ball screw 9b.

As illustrated in FIG. 3, the track 9d is disposed next to the ball screw 9b. The track 9d is fixed at a position off the central axis 81a of the support disk 81. The track 9d extends along the longitudinal direction of the change position arm 84. One end portion of the track 9d faces the change position arm 84. The slider 9e is slidably provided on the track 9d. The pot 9f is attached to the slider 9e. The connecting portion 9g connects the slider 9e and the nut 9c. By the drive of the motor 9a, the ball screw 9b rotates, the nut 9c moves along the ball screw 9b, and the slider 9e, the connecting portion 9g, and the pot 9f move along the track 9d. The pot 9f grabs the tool 50 gripped by the change position arm 84 and passes the tool 50 to the change position arm 6c that is empty or grabs the tool 50 gripped by the change position arm 6c and passes the tool 50 to the change position arm 84 that is empty.

As illustrated in FIGS. 3 and 4, the plurality of arms 83 are arranged along the peripheral edge portion of the support disk 81. The arm 83 extends in the radial direction of the support disk 81. Hereinafter, the configuration of the arm 83 will be described with reference to FIGS. 5 to 13.

The arm 83 includes a first support rod 831 and a second support rod 832. A support plate 83a, the first support rod 831, and the second support rod 832 extend in the front-rear direction. The front end portion of the support plate 83a has a plan-view circular arc shape protruding to the rear side.

The first support rod 831 and the second support rod 832, which are separated from each other in the left-right direction, are disposed on the left side and the right side of the support plate 83a, respectively.

The front-rear-direction midway portion of the first support rod 831 is connected to the front-rear-direction midway portion of the support plate 83a via a pivot 83d, the axial direction of which is the up-down direction. The front-rear-direction midway portion of the second support rod 832 is connected to the front-rear-direction midway portion of the support plate 83a via a pivot 83e, the axial direction of which is the up-down direction. The pivot 83d configures a first pivot. The pivot 83e configures a second pivot.

The side of the first support rod 831 in front of the pivot 83d is referred to as a front side part 831d, and the side of the first support rod 831 behind the pivot 83d is referred to as a rear side part 831e. The side of the second support rod 832 in front of the pivot 83e is referred to as a front side part 832d, and the side of the second support rod 832 behind the pivot 83e is referred to as a rear side part 832e. The front side part 831d of the first support rod 831 is curved so as to protrude to the left side. The front side part 832d of the second support rod 832 is curved so as to protrude to the right side. The front end portion of the support plate 83a, which has a circular arc shape, is disposed between the front side parts 831d and 832d of the first support rod 831 and the second support rod 832.

A spring seat 831c is provided in the rear end portion of the first support rod 831. A spring seat 832c is provided in the rear end portion of the second support rod 832. The two spring seats 831c and 832c form a circular plate shape and face each other in the left-right direction. A push spring 83c is provided between the two spring seats 831c and 832c. The push spring 83c urges the two spring seats 831c and 832c such that the two spring seats 831c and 832c are separated from each other in the left-right direction. Rollers 831b and 832b configure the one end portion 83f of the arm 83, and the spring seats 831c and 832c and the push spring 83c configure the other end portion 83g of the arm 83 (see FIG. 3).

The front side part 831d of the first support rod 831 is positioned to the left of the rear side part 831e. An inclined portion 831a connects the front side part 831d and the rear side part 831e. The inclined portion 831a is inclined so as to extend downward from the rear end portion of the front side part 831d toward the rear side. The roller 831b is provided on the lower surface of the front end portion of the front side part 831d. The front side part 831d configures a first part, and the inclined portion 831a configures a first inclined portion. The roller 831b configures a first grip portion. The up-down direction is parallel to the rotation axis direction of the tool magazine 80.

The front side part 832d of the second support rod 832 is positioned to the right of the rear side part 832e. An inclined portion 832a connects the front side part 832d and the rear side part 832e. The inclined portion 832a is inclined so as to extend upward from the rear end portion of the front side part 832d toward the rear side. The roller 832b is provided on the upper surface of the front end portion of the front side part 832d. The front side part 832d configures a second part, the inclined portion 832a configures a second inclined portion, and the roller 832b configures a second grip portion.

The first support rod 831 and the second support rod 832 are the same component and are simply upside down. The positions of the pivot 83d and the pivot 83e are the same in the direction parallel to the rotation axis direction of the tool magazine 80. The inclination directions of the inclined portion 831a and the inclined portion 832a are opposite to each other, and the inclined portion 831a and the inclined portion 832a have the same inclination angle magnitude. The inclined portion 831a and the inclined portion 832a have the same length. Accordingly, the positions of the roller 831b and the roller 832b are the same in the direction parallel to the rotation axis direction of the tool magazine.

The plurality of arms 83 are arranged along the peripheral edge portion of the support disk 81. The plurality of arms 83 include a first arm 83A and a second arm 83B positioned next to the first arm 83A. The lower surface of the front side part 831d of the first arm 83A is positioned above the upper surface of the front side part 832d of the second arm 83B. The front side part 831d and the front side part 832d are separated from each other in the axial direction of the support disk 81. In the adjacent first arm 83A and second arm 83B, the positions of the front side part 831d of the first arm 83A and the front side part 832d of the second arm 83B are misaligned in the up-down direction, that is, in the axial direction of the support disk 81.

As described above, the line L1 and the line L2 intersect to form the predetermined angle θ. Accordingly, the first arm 83A and the second arm 83B, that is, the two adjacent arms 83 are at the same position at least in part in the circumferential direction of the support disk 81. However, the front side parts 831d and 832d overlap in the direction parallel to the central axis 81a, that is, the positions of the front side parts 831d and 832d are misaligned in the axial direction of the support disk 81, and thus the two arms 83 adjacent to each other in the circumferential direction do not interfere with each other.

In the above machine tool, the number of the arms 83 that can be installed on the support disk 81 can be increased without increasing the size of the support disk 81 in the radial direction as compared with a case where the plurality of arms 83 are disposed so as not to overlap in the direction parallel to the central axis 81a.

The tool 50 is mounted between the front side parts 831d and 832d of the first support rod 831 and the second support rod 832. The rollers 831b and 832b hold the tool 50 by the urging force of the push spring 83c.

In the machine tool of the embodiment, the positions of the first support rod 831 and the second support rod 832, that is, the positions of both side parts of the arm 83 in the circumferential direction of the central axis 81a are different in the direction parallel to the central axis 81a. Accordingly, the two adjacent arms 83 can be overlapped in the direction parallel to the central axis 81a simply by arranging the arms 83 in the circumferential direction of the support disk 81. In other words, the position of the other arm 83 as a whole with respect to one arm 83 does not have to be misaligned in the direction parallel to the central axis 81a in order to overlap the two adjacent arms 83 in the direction parallel to the central axis 81a, and an increase in size in the direction parallel to the central axis 81a can be suppressed.

The arm 83 is disposed so as to intersect the line L1 passing through the center of the support disk 81 and extending in the radial direction of the central axis 81a. With such a disposition, at least a part of each of the two adjacent arms 83 overlaps the other with ease.

In addition, the first support rod 831 of one arm 83 and the second support rod 832 of the other arm 83 overlap each other. Accordingly, interference between the arms 83 and an increase in size in the direction parallel to the central axis 81a are suppressed.

The rollers 831b and 832b are examples of a grip portion, and hemispherical bodies, pins, or plungers may be used instead of the rollers. The push spring 83c is an example of an urging member, and rubber may be used instead of the push spring 83c. An urging member may be provided between the front side parts 831d and 832d. In this case, a pull spring may be used as an urging member.

The arms 83 may be disposed such that the positions of the two adjacent arms 83 are misaligned from each other in the radial direction of the support disk 81. Also in the first magazine 6, the configuration of the first magazine 6 may be similar to the configuration of the second magazine 80 so that the arms 6b do not interfere with each other and an increase in size in the direction parallel to the central axis of the disk 6a is suppressed.

The embodiments disclosed this time are exemplary in all respects and are not restrictive. The technical features described in the examples can be combined with each other and the scope of the present invention includes all modifications within the claims and scopes equivalent to the claims. It is to be noted that, as used herein and in the appended claims, the singular forms “a”, “an”, and “the” include plural referents unless the context clearly dictates otherwise.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

What is claimed is:

1. An arm provided in a tool magazine of a machine tool and configured to grip a tool, the arm comprising:
a support plate configured to be fixed to the tool magazine; and
two support rods configured to rotate on both sides of the support plate,
wherein positions of tool grip side end portions of the two support rods are different in a rotation center axis direction which is a direction of an axis of a rotation center of the tool magazine.

2. The arm according to claim 1,
wherein the tool grip side end portion of one of the support rods and the tool grip side end portion of the other support rod are separated from each other in the rotation center axis direction.

3. The arm according to claim 1, wherein
one of the support rods has:
a first part extending in a direction orthogonal to the rotation center axis of the tool magazine;
a first inclined portion extending toward one direction parallel to the rotation center axis from one end portion of the first part; and
a first grip portion provided on the same side as the one direction in the other end portion of the first part and configured to grip a tool,
the other support rod has:
a second part extending in a direction orthogonal to the rotation center axis;
a second inclined portion extending toward the other direction parallel to the rotation center axis from one end portion of the second part; and
a second grip portion fixed to the same side as the other direction in the other end portion of the second part and configured to grip a tool, and
the first grip portion and the second grip portion are at the same position in the rotation center axis direction.

4. The arm according to claim 3, wherein
one of the support rods includes a first pivot extending in the direction parallel to the rotation center axis,
the first inclined portion is connected to the first pivot,
the other support rod includes a second pivot extending in the direction parallel to the rotation center axis,
the second inclined portion is connected to the second pivot,
positions of the first pivot and the second pivot in the direction parallel to the rotation center axis are the same,
inclination angle magnitudes of the first inclined portion and the second inclined portion are the same, and
lengths of the first inclined portion and the second inclined portion are the same.

5. The arm according to claim 4, wherein
an urging member urging the first grip portion and the second grip portion in a closing direction is provided between the two support rods.

6. A tool magazine comprising the arm according to claim 1 provided on a turntable, wherein
one end portion of the arm protrudes outward from a peripheral edge portion of the turntable in a direction intersecting a rotation center axis of the turntable, and
the other end portion of the arm is disposed at a position not facing an axis of rotation of the turntable in a longitudinal direction of the arm.

7. A machine tool comprising the tool magazine according to claim 6.

8. An arm configured to grip a tool, the arm comprising:
a support plate configured to be fixed to a tool magazine of a machine tool, the support plate having an arc shape portion at one end of the support plate in a first direction;
a first support rod rotatably disposed on one side of the support plate in a second direction, the first support rod having a first part, the first part having a first surface facing one direction of a third direction, the second direction being orthogonal to the first direction, and the third direction being orthogonal to the first direction, second direction, and the support plate;
a second support rod rotatably disposed on the other side of the support plate in the second direction, the second support rod having a second part, the second part having a second surface facing the other direction of the third direction, the one end of the support plate being positioned between the first part of the first support rod and the second part of the second support rod in the second direction, and the second surface of the second part being positioned away from the first surface of the first part in the one direction of the third direction.
